(19) United States
(12) Patent Application Publication
(10) Pub. No.: US 2023/0251470 A1
(43) Pub. Date: Aug. 10, 2023

(54) OPTICAL LENS

(71) Applicant: SUN YANG OPTICS DEVELOPMENT CO., LTD., TAOYUAN CITY (TW)

(72) Inventors: SHENG DA JIANG, TAOYUAN CITY (TW); SHENG CHE WU, TAOYUAN CITY (TW)

(21) Appl. No.: 17/668,700

(22) Filed: Feb. 10, 2022

(51) Int. Cl. G02B 15/14; G02B 27/00; G02B 5/00

(52) U.S. Cl. CPC G02B 15/142; G02B 27/0025; G02B 5/005

(57) ABSTRACT

An optical lens, comprising: an enlarging side and a shrinking side, between the enlarging side and the shrinking side sequentially having a first group lens, a light diaphragm, and a second group lens, wherein the light diaphragm is for separating the first group lens and the second group lens; the first group lens having multiple lenses, and the second lens is an aspheric lens; the second group lens having at least four lenses, wherein at least one lens is an aspheric lens and a positive diopter lens is an aspheric lens; the first group lens and the second group lens having two set of doublet lens.

### BACKGROUND OF THE INVENTION

### 1. Field of the Invention

The present invention relates to an optical lens, particularly to one that using aspheric lens to improve image resolution, and using two doublet lens to achieve having the optical lens that improve chromatic aberration and optical aberration.

### 2. Description of the Related Art

Because of the short focal length (less than 35 mm), the wide-angle lens can provide a wide scope of shooting, and because of the large scope, wide-angle lenses are mostly used for distant scenes or occasions that require a wide range of focus. It can also be used to enlarge the narrow space or present a distorted view. Ultra-wide-angle is also called Fisheye lenses, which can produce greater deformation. Generally, a fisheye lens refers to a special lens with an angle of view close to or equal to 180°, which is characterized by being able to capture a wider range than a wide-angle lens.

Due to safety considerations in modern cars, the demand for image capture from all angles is increasing. Therefore, fisheye lenses with a wide field of view (FOV) have become the first choice for dashboard camera and security cameras; furthermore, as the field of view is expanded, the number of lenses must be increased or aspheric lenses must be added to correct the optical aberrations caused by large viewing angles, so the length of the lens will increase, and the cost of the lens will also increase; generally speaking, if the volume of the fisheye lens increases, the performance of its chromatic aberration and optical aberration will deteriorate, but it is very difficult to reduce the size of the fisheye lens and to balance the performance of good chromatic aberration and optical aberration. Also, chromatic aberration refers to the phenomenon that the optical lens cannot focus the color light of various wavelengths on the same point; and the optical aberration is the deviation of the actual imaging from the ideal imaging of a single lens, and these deviations are caused by refraction. Therefore, how to produce an optical lens that has a wide field of view, high resolution, large aperture, can reduce the total track length (TTL), and can achieve good chromatic aberration and optical aberration improvement effects is what the inventor wants to achieve.

### SUMMARY OF THE INVENTION

A primary objective of the present invention is to provide an optical lens which has wide field of view, high resolution, large aperture, can reduce the total track length, and can achieve good chromatic aberration and optical aberration improvement effect.

To achieve the objects mentioned above, the present invention comprises an enlarging side and a shrinking side, between the enlarging side and the shrinking side sequentially having a first group lens, a light diaphragm, and a second group lens, wherein the light diaphragm is for separating the first group lens and the second group lens; the first group lens having multiple lenses, and the second lens is an aspheric lens; the second group lens having at least four lenses, wherein at least one lens is an aspheric lens and a positive diopter lens is an aspheric lens; the first group lens and the second group lens having two set of doublet lens; and the optical lens meets the conditions of 0.10<IHmax/TTL<0.24 and 0.024<IHmax/half-HOV<0.032, where IHmax is the maximum imaging height of the optical lens, TTL is the total track length of the optical lens, and half-HON/is the half field of view of the optical lens.

The aforementioned “light diaphragm” component refers to a rectangular or circular aperture in the optical system that can restrict the beam; it is generally used to control the intensity of light, reduce aberrations, and increase the depth of focus; The smaller the light diaphragm, the smaller the aberration, the larger the depth of field, and the clearer the image, but the brightness decreases. In addition, a “doublet lens” component refers to a lens in which multiple single lenses with different refractive indices and chromatic aberrations are bonded together using an adhesive; the main function of a doublet lens is to reduce chromatic aberration and other optical aberrations in the optical system.

Also, behind the light diaphragm has a doublet lens, and from the enlarging side to the shrinking side, sequentially formed by a positive diopter lens and a negative diopter lens; and the diopter lens that closest to the shrinking side is a doublet lens, and from the enlarging side to the shrinking side, sequentially formed by a positive diopter lens and a negative diopter lens.

Also, behind the light diaphragm has a doublet lens, and from the enlarging side to the shrinking side, sequentially having a positive diopter lens, a negative diopter lens and a positive diopter lens.

Also, the index of the first lens of the first group lens is larger than 1.8.

Also, in front of the light diaphragm has a positive diopter lens or a positive diopter doublet lens.

Also, the lens behind and in front of the light diaphragm are a spherical lens.

Since the optical lens of the present invention is using the aspheric lens in the first group lens and the second group lens to improve the resolution quality of the lens, and using two doublet lens to achieve confocal effect of visible light and infrared light, thereby obtaining good chromatic aberration and optical aberration improvement effects; meanwhile, the total track length (TTL) of the optical lens of the present invention will be less than 17 mm, and the field of view (FOV) can be greater than 180 degrees: therefore, the present invention can meet the requirements of small size, and easy manufacturing.

### BRIEF DESCRIPTION OF THE DRAWINGS

FIG. 1 is a schematic diagram illustrating lenses arrangement of the first embodiment the present invention;

FIG. 2 is an oscillogram of the first embodiment the present invention when achieving confocal effect;

FIG. 3 is a schematic diagram illustrating lenses arrangement of the second embodiment the present invention;

FIG. 4 is an oscillogram of the second embodiment the present invention when achieving confocal effect.

### DETAILED DESCRIPTION OF THE PREFERRED EMBODIMENT

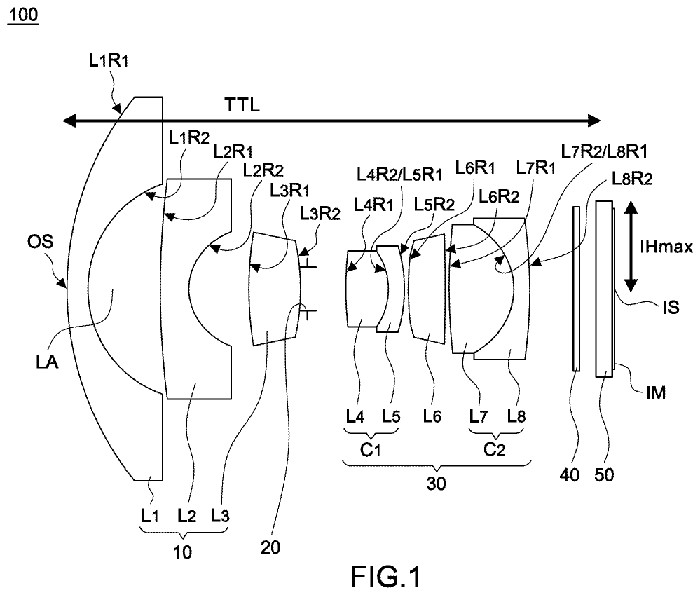

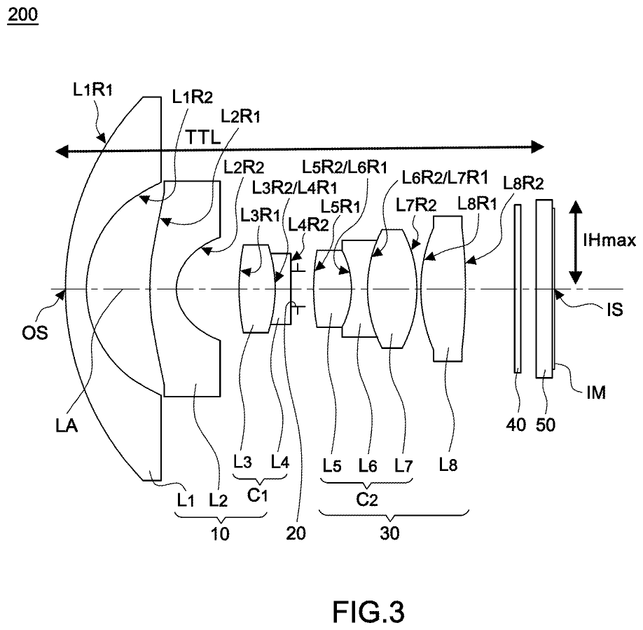

Referring to FIGS. 1-3, an optical lens 100 of the first embodiment and an optical lens 200 of the second embodiment, both of them comprising: a first group lens 10, a light diaphragm 20, a second group lens 30, an infrared filter 40, and a glass cover 50 sequentially arranged between an enlarging side OS and a shrinking side IS, wherein the light diaphragm 20 is for separating the first group lens 10 and the second group lens 30, the first group lens 10 and the second group lens 30 are arranged along an optical axis LA; in these two embodiments, the total track length TTL of the optical lens from the enlarging side OS to the a shrinking side IS is approximately 17 mm, also, the glass cover 50 is set at the shrinking side IS and arranged between the second group lens 30 and an image side IM; and the infrared filter 40 is set between the second group lens 30 and the glass cover 50, in order to let the optical lens 100/200 be able to produce an image at the image side IM.

Moreover, the optical lens 100 of the first embodiment showing in FIG. 1, the first group lens 10 comprising multiple lenses (from the enlarging side OS to the shrinking side IS sequentially having a first lens L1, a second lens L2, and a third lens L3), wherein the second lens L2 is an aspheric lens, and the first lens L1 and the third lens L3 are a spherical lens; Furthermore, the second group lens 30 comprising at least four lenses (from the enlarging side OS to the shrinking side IS sequentially having a fourth lens L4, a fifth lens L5, a sixth lens L6, a seventh lens L7, and an eighth lens L8), wherein the fourth lens L4, the fifth lens L5, the seventh lens L7 and the eighth lens L8 are a spherical lens, and the sixth lens L6 is an aspheric lens, also, a positive diopter lens which is aspheric lens is included (which is the sixth lens L6); also, the first group lens 10 and second group lens 30 include two set of doublets lens (the fourth lens L4 and the fifth lens L5 form the first doublets lens C1, and the seventh lens L7 and the eighth lens L8 form the second doublets lens C2); and behind the light diaphragm 20 set a set of doublet lens (which is the first doublets lens C1), and sequentially set a positive diopter lens (which is the fourth lens L4) and a negative diopter lens (which is the fifth lens L5),

and the diopter lens that closest to the shrinking side is a doublet lens (which is the second doublets lens C2), and from the enlarging side to the shrinking side, sequentially formed by a positive diopter lens (which is the seventh lens L7) and a negative diopter lens (which is the eighth lens L8); Furthermore, the index of the first lens L1 of the first group lens 10 is larger than the 1.8; the lens behind (the fourth lens L4) and in front of (the third lens L3) the light diaphragm 20 are a spherical lens.

In the first embodiment, as tablet below showing, the lens type, the radius, the thickness, the index and the abbe number of the first lens L1, the second lens L2, the third lens L3, the fourth lens L4, the fifth lens L5, the sixth lens L6, the seventh lens L7 and the eighth lens L8:

TABLE 1

| | Type | Radius | Thickness | Index | Abbe |
|---|---|---|---|---|---|
| L1R1 | SPH | 11.4 | 0.65 | 1.883 | 39.2 |
| L1R2 | SPH | 4 | 2.24 | | |
| L2R1 | ASP | Infinity | 0.88 | 1.544 | 56 |
| L2R2 | ASP | 2 | 1.85 | | |
| L3R1 | SPH | 13.1 | 1.59 | 1.946 | 17.9 |
| L3R2 | SPH | −9.5 | 1.17 | | |
| STOP | SPH | Infinity | 0.25 | | |
| L4R1 | SPH | 24.6 | 1.33 | 1.741 | 52.7 |
| L4R2/L5R1 | SPH | −2.5 | 0.5 | 1.946 | 17.9 |
| L5R2 | SPH | −5.7 | 0.1 | | |
| L6R1 | ASP | 16.3 | 1.15 | 1.544 | 56 |
| L6R2 | ASP | −8.5 | 0.1 | | |
| L7R1 | SPH | 21 | 2 | 1.883 | 39.2 |
| L7R2/L8R1 | SPH | −2.6 | 0.5 | 1.808 | 22.7 |
| L8R2 | SPH | −24.3 | 1.34 | | |
| FILTER | SPH | Infinity | 0.21 | 1.516 | 64.1 |
| | SPH | Infinity | 0.5 | | |
| CG | SPH | Infinity | 0.5 | 1.516 | 64.1 |
| | SPH | Infinity | 0.05 | | |

Furthermore, the L1R1 and the L1R2 is the object side surface and the image side surface of the first lens L1 respectively; the L2R1 and the L2R2 is the object side surface and the image side surface of the second lens L2 respectively; the L3R1 and the L3R2 is the object side surface and the image side surface of the third lens L3 respectively; the L4R1 and the L4R2 is the object side surface and the image side surface of the fourth lens L4 respectively; the L5R1 and the L5R2 is the object side surface and the image side surface of the fifth lens L5 respectively; the L6R1 and the L6R2 is the object side surface and the image side surface of the sixth lens L6 respectively; the L7R1 and the L7R2 is the object side surface and the image side surface of the seventh lens L7 respectively; the L8R1 and the L8R2 is the object side surface and the image side surface of the eighth lens L8 respectively; wherein L1R1, L1R2, L3R1, L3R2, L4R1, L4R2, L5R1, L5R2, L7R1, L7R2, L8R1, L8R2 are spherical, and L2R1, L2R2, L6R1, L6R2 are aspherical. In this embodiment, the optical lens 100 is made according to the value list on the Table 1, wherein the IHmax/TTL=0.164, and the IHmax/half-HOV=0.0277, IHmax stands for the maximum imaging height, TTL stands for the total length of the optical lens, half-HOV stands for the half field of view of the optical lens.

In accordance with Table 2, the L2R1, L2R2, L6R1, L6R2 are the object side surface and the image side surface of the aspherical lens respectively, and the conic coefficient (K) of the aspherical lens is listed in the table 2, and the aspheric coefficients of 4TH, 6TH, 8TH, 10TH, 12TH, 14TH are listed in the table 2.

TABLE 2

| | L2R1 | L2R2 | L6R1 | L6R2 |
|---|---|---|---|---|
| R | Infinity | 2 | 16.3 | −8.5 |
| K | 0 | −0.579 | −18.721 | −9.087 |
| 4th | 1.01E−02 | 1.84E−02 | 1.03E−02 | 1.38E−02 |
| 6th | −2.21E−03 | 2.56E−04 | −5.68E−04 | −1.15E−03 |
| 8th | 2.70E−04 | −1.37E−03 | 2.20E−03 | 2.79E−03 |
| 10th | −2.02E−05 | 3.86E−04 | −1.32E−03 | −1.38E−03 |
| 12th | 8.57E−07 | −4.13E−05 | 3.72E−04 | 3.59E−04 |
| 14th | −1.57E−08 | 1.05E−06 | −4.20E−05 | −3.76E−05 |

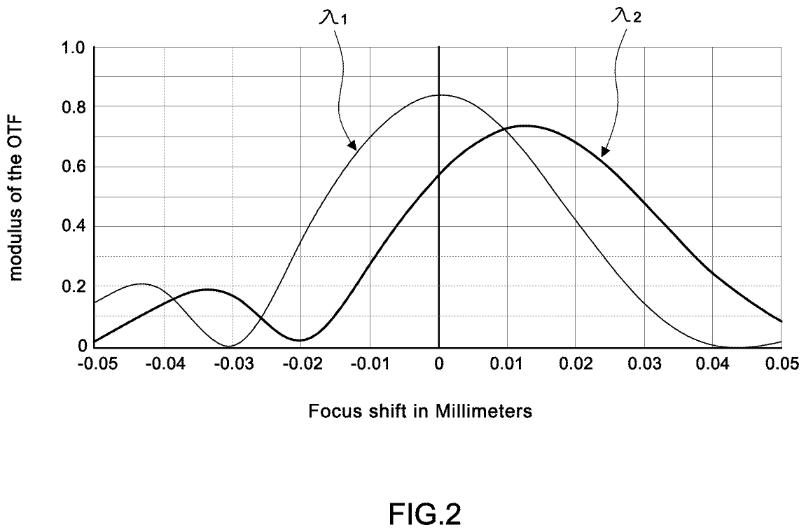

The optical lens 100 of the first embodiment of the present invention passes through the visible light wavelength λ1 of 400-700 nm and the infrared light wavelength λ2 of 940 nm, the focal length offset of the two is smaller than 0.015 mm, and the image of the contrast ratio of the sine wave of the two and the Modulus of the OTF are smaller than 0.1 when the spatial frequency is 831p/mm, as showing in FIG. 2; since the optical lens 100 of the first embodiment can drive visible light and infrared light to achieve confocal effect; therefore, this embodiment can achieve good chromatic aberration and optical aberration improvement effect.

Moreover, the optical lens 200 of the second embodiment showing in FIG. 1, the first group lens 10 comprising multiple lenses (from the enlarging side OS to the shrinking side IS sequentially having a first lens L1, a second lens L2, a third lens L3, and a fourth lens L4), wherein the second lens L2 is an aspheric lens, and the first lens L1 and the third lens L3, and the fourth lens L4 are a spherical lens; Furthermore, the second group lens 30 comprising at least four lenses (from the enlarging side OS to the shrinking side IS sequentially having a fourth lens L4, a fifth lens L5, a sixth lens L6, a seventh lens L7, and an eighth lens L8), wherein the fifth lens L5, the sixth lens L6, and the seventh lens L7 are a spherical lens, and the eighth lens L8 is an aspheric lens, also, a positive diopter lens which is aspheric lens is included (which is the eighth lens L8); also, the first group lens 10 and second group lens 30 include two set of doublets lens (the third lens L3 and the fourth lens L4 form the first doublets lens C1, and the fifth lens L5, the sixth lens L6, and the seventh lens L7 form the second doublets lens C2); and behind the light diaphragm 20 set a set of doublet lens (which is the first doublets lens C2), and sequentially set a positive diopter lens (which is the fifth lens L5) and a negative diopter lens (which is the sixth lens L6), a positive diopter lens (which is the seventh lens L7); Furthermore, the index of the first lens L1 of the first group lens 10 is larger than the 1.8; in front of the light diaphragm 20 set a positive diopter lens (the third lens L3) or a positive diopter doublets lens (the first doublets lens C1); the lens behind (the fifth lens L5) and in front of (the fourth lens L4) the light diaphragm 20 are a spherical lens.

In the second embodiment, as tablet below showing, the lens type, the radius, the thickness, the index and the abbe number of the first lens L1, the second lens L2, the third lens L3, the fourth lens L4, the fifth lens L5, the sixth lens L6, the seventh lens L7 and the eighth lens L8:

TABLE 3

| | Type | Radius | Thickness | Index | Abbe |
|---|---|---|---|---|---|
| L1R1 | SPH | 11.5 | 0.74 | 1.883 | 40.8 |
| L1R2 | SPH | 4.6 | 2.21 | | |
| L2R1 | ASP | 6.8 | 0.93 | 1.56 | 42 |
| L2R2 | ASP | 1.5 | 2.19 | | |
| L3R1 | SPH | 9.6 | 1.27 | 1.946 | 17.9 |
| L3R2/L4R1 | SPH | −6.5 | 0.55 | 1.497 | 81.5 |
| L4R2 | SPH | 38.1 | 0.28 | | |
| STOP | SPH | Infinity | 0.51 | | |
| L5R1 | SPH | 8.8 | 1.34 | 1.682 | 57.5 |
| L5R2/L6R1 | SPH | −3.3 | 0.55 | 1.905 | 18.6 |
| L6R2/L7R1 | SPH | 5.2 | 1.75 | 1.883 | 40..8 |
| L7R2 | SPH | −5 | 0.1 | | |
| L8R1 | ASP | 5.1 | 1.58 | 1.544 | 56 |
| L8R2 | ASP | −18.3 | 1.75 | | |
| FILTER | SPH | Infinity | 0.21 | 1.516 | 64.1 |
| | SPH | Infinity | 0.5 | | |
| CG | SPH | Infinity | 0.5 | 1.516 | 64.1 |
| | SPH | Infinity | 0.05 | | |

Furthermore, the L1R1 and the L1R2 is the object side surface and the image side surface of the first lens L1 respectively; the L2R1 and the L2R2 is the object side surface and the image side surface of the second lens L2 respectively; the L3R1 and the L3R2 is the object side surface and the image side surface of the third lens L3 respectively; the L4R1 and the L4R2 is the object side surface and the image side surface of the fourth lens L4 respectively; the L5R1 and the L5R2 is the object side surface and the image side surface of the fifth lens L5 respectively; the L6R1 and the L6R2 is the object side surface and the image side surface of the sixth lens L6 respectively; the L7R1 and the L7R2 is the object side surface and the image side surface of the seventh lens L7 respectively; the L8R1 and the L8R2 is the object side surface and the image side surface of the eighth lens L8 respectively; wherein L1R1, L1R2, L3R1, L3R2, L4R1, L4R2, L5R1, L5R2, L6R1, L6R2, L7R1, L7R2 are spherical, and L2R1, L2R2, L8R1, L8R2 are aspherical. In this embodiment, the optical lens 200 is made according to the value list on the Table 3, wherein the IHmax/TTL=0.185, and the IHmax/half-HOV=0.0285, IHmax stands for the maximum imaging height, TTL stands for the total length of the optical lens, half-HOV stands for the half field of view of the optical lens.

In accordance with Table 4, the L2R1, L2R2, L8R1, L8R2 are the object side surface and the image side surface of the aspherical lens respectively, and the conic coefficient (K) of the aspherical lens is listed in the table 2, and the aspheric coefficients of 4TH, 6TH, 8TH, 10TH, 12TH, 14TH are listed in the table 4.

TABLE 4

| | L2R1 | L2R2 | L8R1 | L8R2 |
|---|---|---|---|---|
| R | 6.80E+00 | 1.5 | 5.1 | −18.3 |
| K | −7.667 | −0.703 | −1.871 | 20 |
| 4th | −8.44E−04 | 2.74E−04 | −8.64E−04 | 4.56E−03 |
| 6th | −6.28E−04 | −2.77E−03 | −3.03E−04 | −7.38E−04 |
| 8th | 1.16E−04 | 6.74E−04 | −6.86E−05 | −4.07E−05 |
| 10th | −9.06E−06 | −3.50E−04 | 2.59E−05 | 3.37E−05 |
| 12th | 3.47E−07 | 1.31E−04 | −3.87E−06 | −4.99E−06 |
| 14th | −5.35E−09 | −1.47E−05 | 2.31E−07 | 3.12E−07 |

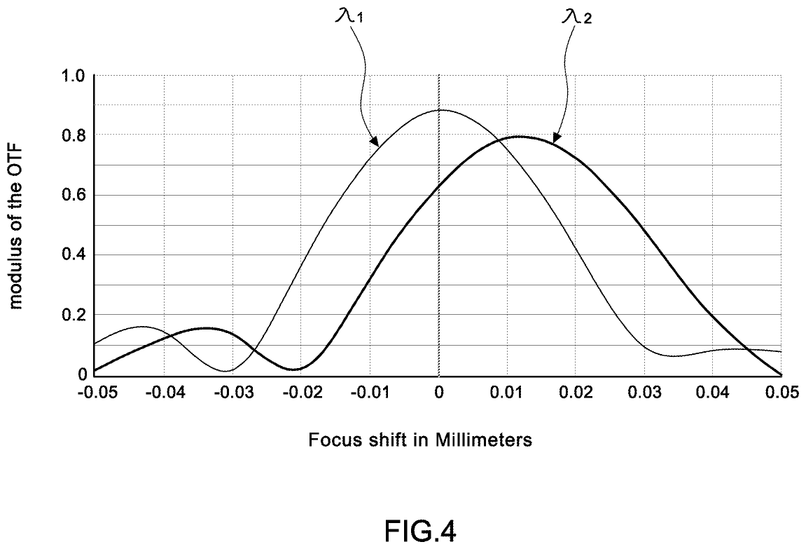

The optical lens 200 of the second embodiment of the present invention passes through the visible light wavelength λ1 of 400-700 nm and the infrared light wavelength λ2 of 940 nm, the focal length offset of the two is smaller than 0.015 mm, and the image of the contrast ratio of the sine wave of the two and the Modulus of the OTF are smaller than 0.1 when the spatial frequency is 831p/mm, as showing in FIG. 4; since the optical lens 200 of the second embodiment can drive visible light and infrared light to achieve confocal effect; therefore, this embodiment can achieve good chromatic aberration and optical aberration improvement effect.

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. An optical lens, comprising:
an enlarging side and a shrinking side, between the enlarging side and the shrinking side sequentially having a first group lens, a light diaphragm, and a second group lens, wherein the light diaphragm is for separating the first group lens and the second group lens;
the first group lens having multiple lenses, and the second lens thereof is an aspheric lens;
the second group lens having at least four lenses, wherein at least one lens thereof is an aspheric lens, and a positive diopter lens is an aspheric lens; and
the first group lens and the second group lens having two set of doublet lens.

2. The optical lens as claimed in claim 1, wherein the optical lens meets the conditions of 0.10<IHmax/TTL<0.24 and 0.024<IHmax/half-HOV<0.032, where IHmax is the maximum imaging height of the optical lens, TTL is the total track length of the optical lens, and half-HOV is the half field of view of the optical lens.

3. The optical lens as claimed in claim 1, wherein behind the light diaphragm has a doublet lens, and from the enlarging side to the shrinking side, sequentially formed by a positive diopter lens and a negative diopter lens; and the diopter lens that closest to the shrinking side is a doublet lens, and from the enlarging side to the shrinking side, sequentially formed by a positive diopter lens and a negative diopter lens.

4. The optical lens as claimed in claim 1, wherein behind the light diaphragm has a doublet lens, and from the enlarging side to the shrinking side, sequentially having a positive diopter lens, a negative diopter lens and a positive diopter lens.

5. The optical lens as claimed in claim 1, wherein the index of the first lens of the first group lens is larger than 1.8.

6. The optical lens as claimed in claim 1, wherein in front of the light diaphragm has a positive diopter lens or a positive diopter doublet lens.

7. The optical lens as claimed in claim 1, wherein the lens behind and in front of the light diaphragm are a spherical lens.
